(19) United States
(12) Patent Application Publication
(10) Pub. No.: US 2026/0145392 A1
(43) Pub. Date: May 28, 2026

(54) 3D PRINTER AND METHOD OF OPERATING THE 3D PRINTER

(71) Applicants: Friedrich-Alexander-Universität Erlangen-Nürnberg, In Vertretung des Freistaates Bayern, Erlangen (DE); Julius-Maximilians-Universität Würzburg, In Vertretung des Freistaates Bayern, Würzburg (DE)

(72) Inventors: Jürgen GROLL, Eibelstadt (DE); Zan LAMBERGER, Würzburg (DE); Gregor LANG, Bayreuth (DE); Stefan SCHRÜFER, Erlangen (DE); Dirk Wolfram SCHUBERT, Eggolsheim (DE)

(21) Appl. No.: 19/453,139

(22) Filed: Jan. 20, 2026

Related U.S. Application Data
(63) Continuation of application No. PCT/EP2024/069950, filed on Jul. 12, 2024.

(30) Foreign Application Priority Data
Jul. 20, 2023 (DE) 10 2023 206 928.8

(51) Int. Cl. B29C 64/393; B29C 64/209; B33Y 10/00; B33Y 30/00; B33Y 50/02

(52) U.S. Cl. CPC B29C 64/393; B29C 64/209; B29K 2995/0026; B33Y 10/00; B33Y 30/00; B33Y 50/02

(57) ABSTRACT

A 3D printer is specified which has a print head for extruding a transparent ink filament and a transparent printing plate for depositing the extruded ink filament. Furthermore, the 3D printer has an imaging apparatus which provides a pattern composed at least of straight stripes and an optical capture device which is configured to capture an image of the pattern and of the deposited ink filament from a bottom side of the printing plate during the specified printing operation of the 3D printer. Furthermore, the 3D printer has a controller which is configured to derive at least one characteristic value for the printing operation from the image captured by the capture device.

### CROSS-REFERENCE TO RELATED APPLICATION

This application is a continuation, under 35 U.S.C. § 120, of copending International Patent Application PCT/EP2024/069950, filed Jul. 12, 2024, which designated the United States; this application also claims the priority, under 35 U.S.C. § 119, of German Patent Application DE 10 2023 206 928.8, filed Jul. 20, 2023; the prior applications are herewith incorporated by reference in their entirety.

### FIELD AND BACKGROUND OF THE INVENTION

The invention relates to a 3D printer.

3D printers were originally used for prototype production, or at most for small-scale production. The primary goal was to avoid costly processes such as injection molding, as those require costly injection molding tools. The simplest form of such “rapid prototyping” processes is so-called “Fused Deposition Modeling” (FDM), in which thermoplastic material is usually melted and deposited in filaments in a web-like and layer-by-layer manner using an extruder nozzle on a usually heated plate, mostly in a heated space. Through appropriate process control, a three-dimensional structure with a sub-millimeter resolution can be produced by fusing the filaments together. The coordinates are usually provided to the 3D printer based on CAD models that are converted into layer-by-layer paths—so-called “G-codes”—using what is referred to as slicer software. Since the development of this “bottom-up” concept, numerous other 3D printing methods have been developed. In some cases, other material classes are also used, such as photo-cross-linkable resins, which are then solidified into a component using stereolithography. The use of such manufacturing methods is increasingly being pursued not only for small-scale but also large-scale production, and even for single components. Owing to the stepwise manner in which they tackle production tasks, these manufacturing methods are also referred to by the umbrella term of “additive manufacturing.”

Intensive research is also being conducted in the field of regenerative medicine on the adaptation of additive manufacturing processes in order to enable tissues or even organs to be produced artificially. In so-called bio-fabrication, living cells are printed together with biocompatible materials to create three-dimensional structures with defined pore sizes. To enable cell survival and tissue maturation, use is made particularly of hydrogel-forming materials which primarily mimic the natural extracellular matrix of native tissue. For example, biomaterials based on collagen, gelatin, fibrin, hyaluronic acid, alginate and silk proteins, or synthetic polymers such as PEGDA or POx and various blends and chemically modified variants thereof are used. The FDM process is frequently used in bio-fabrication because, unlike the inkjet process, which is also used for printing cells, a wider range of materials can be processed, and it enables 3D structures to be produced in a relatively short time.

For processing, the materials must first be brought into a liquid, malleable state—e.g., melt, hydrogel, or precursor solution—in order to then retain a defined 3D shape after a phase transition. The flow characteristics (or rheological properties) of the materials to be processed are of crucial importance both to the processing and to the dimensional stability of the product. The main characteristic is usually what is referred to as viscosity. It describes the relationship between shear stress and shear rate. Shear stress is the stress that must be applied to deform a fluid at a certain shear rate. “Low viscosity” therefore means that low stresses are required to deform a fluid. These are therefore thin fluids, whereas an increasing viscosity (i.e., a viscosity with higher values, or “high viscosity”) describes an increase in the “thickness” of the fluid. If there is a linear relationship between shear stress and shear rate, then the viscosity is independent of the shear rate and therefore constant; this is referred to as Newtonian flow behavior, which applies to water and many oils, for example.

More complex systems, such as polymer melts, high-molecular-weight and concentrated solutions, or multiphase systems such as suspensions, often do not exhibit Newtonian behavior, as their viscosity frequently depends on the shear rate or other factors such as time-dependent structural changes of the material. Polymer melts and highly concentrated solutions usually exhibit shear-thinning behavior, meaning that their viscosity decreases as the shear rate increases. Physical hydrogels can be destabilized under high shear stress and converted into a liquid state, which enables them to be processed using an extrusion printing process. Such hydrogels or precursors thereof (i.e., aqueous solutions) that are loaded with cells and can be converted into a gel immediately after printing (by self-assembly or targeted crosslinking by means of ions, for example, or through irradiation) are referred to below as “bioinks.” The print resolution depends on the dimensional stability of the deposited filament, which ideally should spread—i.e., flow apart—as little as possible. How far (or strongly) the filament can spread depends, in turn, on the relationship between (temporal) throughput, viscosity, and the rate of gelation. The difficulty in process optimization posed by bioprinting therefore lies partly in systematically capturing the interplay of the parameters involved and optimizing them in a feedback loop. For this purpose, the time-resolved flow behavior of the printed filament must be captured and documented, quantified, and ideally modeled as a function of parameters (pressure, flow rate, deposition rate, temperature, viscosity, etc.). However, determining the throughput is often difficult to achieve solely based on set process parameters (pressure, temperature, and the like), especially with relatively low-viscosity materials and/or due to nonlinear flow behavior (e.g., structural viscosity and the like).

### SUMMARY OF THE INVENTION

It is the object of the invention to specify an improved 3D printer.

This object is achieved according to the invention by a 3D printer with the features of the independent 3D printer claim. Moreover, this object is achieved according to the invention by a method with the features of the independent method claim. Additional advantageous refinements, of the invention, which are inherently inventive in and of themselves are set out in the subclaims and the following description.

The 3D printer according to the invention has a print head which serves to extrude an ink filament that is at least initially transparent. Furthermore, the 3D printer has a transparent printing plate for depositing the extruded ink filament. Furthermore, the 3D printer has an imaging apparatus which provides a pattern composed at least of straight, preferably also at least partially parallel, stripes (or lines), as well as an optical capture device that is designed to capture an image of the pattern and of the deposited ink filament from a bottom side of the printing plate during the specified printing operation of the 3D printer. Furthermore, the 3D printer has a controller which is designed to derive at least one characteristic value for printing operation from the image captured by the scanning device.

Here and below, the expression “at least initially transparent” refers in particular to the fact that the ink filament, particularly the ink used, is transparent after extrusion for at least a certain period of time (e.g., up to 5 or 10 seconds), in particular until solidification (due to crosslinking and/or crystallization) begins or has progressed to a certain degree, and may optionally become opaque thereafter.

The method according to the invention serves to operate a 3D printer, in particular the one described above. A transparent ink filament is extruded using a print head (particularly the one mentioned above) of the 3D printer and deposited on a transparent printing plate (particularly the one mentioned above). Furthermore, an imaging apparatus (particularly the one mentioned above) is provided which provides a pattern composed at least of straight, and optionally at least partially parallel, stripes. In addition, an image of the pattern and of the deposited ink filament is captured from the bottom side of the printing plate, and at least one characteristic value for the printing operation is derived from the captured image.

Preferably, the controller of the 3D printer is designed to carry out the above-described method, preferably automatically, optionally in interaction with an operator of the 3D printer. Conversely, in optional variants of the method according to the invention, the steps described below as being carried out (or to be carried out) by the controller are performed accordingly. Thus, the 3D printer and the method exhibit the same features and advantages described here and below.

According to the invention, optical characteristics of the deposited ink filament are detected, and the aforementioned characteristic value is deduced from these characteristics. This is advantageous in that it allows for the consideration of characteristics that are a manifestation (consequence) of selected process parameters (e.g., throughput, pressure, feed rate, or the like). However, such determination of the aforementioned characteristic value is decoupled from the aforementioned process parameters. The invention is based on the idea that the image of the pattern captured from below the printing plate is influenced by the transparent ink filament. This influence, in turn, enables inferences to be made about the dimensions of the ink filament and thus about process parameters, particularly the values thereof.

In an optional variant, the controller is set up to employ the characteristic value in regulating or controlling the printing operation.

Preferably, the transparent (printer) ink is a bioink, i.e., a material that is biologically compatible and particularly suitable and intended for use in or on the human body, for example as a tissue replacement, implant, or the like. Such bioinks or biomaterials are preferably based on collagen, gelatin, fibrin, hyaluronic acid, alginate, and/or silk proteins, and additionally or alternatively also on synthetic polymers such as PEGDA or POx as well as various blends and chemically modified variants thereof.

In one expedient embodiment, the imaging apparatus is instantiated by a plate on which the pattern has been printed. Optionally, this plate can also be made transparent and backlit, so that the printed pattern is depicted as a kind of shadow on the printing plate and ink filament.

In an alternative embodiment, the imaging apparatus is instantiated by a screen on which the pattern is displayed.

However, in both the case of the printed plate and the screen, it is preferred that no projection or the like occur on the printing plate and the ink filament. Instead, the pattern is viewed—i.e., captured—by the scanning device by looking through the printing plate and the transparent ink filament.

Advantageously, the imaging apparatus, in particular the plate, is coupled to the print head and is moved along with the same.

In a preferred embodiment, the controller is configured to infer the (preferably local) width, curvature, and/or height of the deposited ink filament from an optical distortion—e.g., a local twist, deformation, and/or change in size—of the pattern, in particular by the ink filament in the image. This is based on the consideration that a transparent ink filament deposited on the printing plate, due to its spreading—particularly under conventional conditions—acts similarly to a (particularly flat-convex) cylindrical lens and thus also locally distorts, particularly twists, the pattern viewed through the ink filament. The width of the ink filament can be determined relatively easily, for example by the beginning and end of a deformation of a single stripe of the pattern, provided that the angular position of the stripe relative to the direction of travel (particularly the printing direction) of the ink filament is known. The curvature and/or height of the ink filament can be determined using optical equations, for example. In particular, the path of the beams through the ink filament, which acts similarly to a cylindrical lens, and through the (at least approximately) plane-parallel printing plate is simulated using formulas from so-called matrix optics, with an optical transfer function (or also: “lens equation”) being created in matrix form. Based on knowledge of the various parameters such as lens curvature, etc., this transfer function can be used, for example, in particular to determine the image size (image height, particularly as the distance of the “outermost” image point from the optical axis), the object size (object height, again particularly as the distance of the “outermost” object point from the optical axis), or even the lens curvature. Based on the capture of the pattern both with and without imaging through the filament, it is readily possible to read out the respective angle of the pattern (in the simplest case, a single stripe) relative to the printing direction. The ratio of the angles (more precisely: the ratio of the two tangents to one another) makes it possible to deduce the ratio of object size to image size. Since it is possible to determine the image size (particularly on an image sensor of the capture device), it is possible to infer the object size. This enables the curvature of the cylindrical lens formed by the ink filament to be determined using the optical transfer function, particularly with knowledge of the respective refractive indices of the ink filament, the printing plate, and the intermediate medium (usually air). From this curvature, the optically detectable width of the ink filament, and the assumption of a parabolic filament profile, it is then possible to determine the height of the ink filament at its apex and the cross-sectional area thereof.

The stripes of the pattern are especially preferably positioned at an angle to a main printing direction (i.e., the direction in which the ink filament runs in a straight-line print without slant—also referred to, for example, as the O° direction). In an especially expedient embodiment, the stripes of the pattern are positioned at an angle of at least approximately 45° (i.e., with a deviation of, for example, up to +/−5°) to the main printing direction. With such an inclined position, a distortion of the pattern or its stripes is made especially apparent compared to a vertical orientation. If the stripes ran parallel to the main printing direction, there would be a risk that no stripe could be viewed through an ink filament, or that a stripe would be arranged in such a way relative to the ink filament that distortion could not be detected or could only be detected with difficulty. In contrast, with an oblique orientation, the probability is especially high that at least one stripe will cover the ink filament. To achieve an especially reliable design, it is also conceivable for the pattern to be composed of intersecting stripes. One refinement of intersecting stripes can be squares, for instance, that are spaced apart from each other or directly adjacent to one another and in particular have an edge length of 1 to 5 cm, preferably up to 2 cm. Optionally, the stripes, or even just some stripes, in a portion of the pattern can be arranged in a star or radial pattern around a common center. For example, these star-shaped stripes are aligned with an angular offset of 5 to 15 degrees to one another. The latter simplifies the detection of distortion or twisting of the stripes in any printing direction.

Optionally, the stripes can also be interrupted (dotted and/or dash-lined) and vary in width. This makes it easier to associate the optical image (i.e., representation) of a specific stripe with its “origin” on the imaging apparatus.

According to another expedient embodiment, the controller is configured to infer a throughput and/or a printing speed (which each constitute the aforementioned characteristic value) from the (respective, particularly local) width, curvature, and/or height of the deposited ink filament. In particular, the controller is configured to determine the (local) cross-sectional area of the ink filament based on at least one of the aforementioned characteristics, particularly the combination thereof (at least width and curvature), and to deduce its volume and volume throughput from this. The local cross section is known to reflect the local throughput. Thus, using a relatively simple optical observation setup, the (volume) throughput can be determined “inline”, i.e., during the process, and optionally used to control or regulate the process. Given a known printing speed and cross-sectional area (calculated from curvature and filament width), the throughput follows as a process-relevant parameter.

In one advantageous embodiment, the controller is also configured to infer the spreading behavior of the ink based on a progression of the width, curvature, and/or height of the deposited ink filament over time. In particular, the development of the ink filament is observed in multiple successive images, and an inference is made about the spreading behavior, i.e., how much the inkjet is spreading out after being deposited (in particular perpendicular to the printing direction or longitudinal extent thereof). Alternatively, a predefined “pattern”—i.e., particularly multiple predefined “capture points” or “measuring points” along the deposited filament—can be viewed in a single image. The respective measuring points are recognizably associated with different timepoints after the filament has been deposited, so that the spreading behavior can also be determined in just one image. The spreading behavior, in turn, provides information about process parameters, particularly their influence on the 3D printed image (which is influenced by the spreading behavior). For example, the degree of pre-gelling or the like can be adjusted if the spreading behavior is outside a target range (too strong or too weak).

In a preferred embodiment, the controller is configured to detect, in a calibration mode, a plurality of calibration filaments which are arranged on the printing plate or on a support to be placed thereon and having a known cross-sectional geometry and to use them to compensate for a measurement deviation. Here and below, “measurement deviation” refers not only to a deviation in an “actual” measurement, such as the optical determination of the width of the ink filament, but also to a calculation of the curvature and/or height of the ink filament based on optical calculations. In particular, for the known dimensions of the calibration filaments, it is especially easy to check whether the measurement of the width or the calculation leads to results that are at least within a predefined tolerance range.

Optionally, this calibration mode can be used as a standalone mode in which only the calibration filaments are measured. Alternatively, the calibration mode can also be provided in parallel with the specified processing, e.g., by arranging the calibration filaments in a non-printable area on the printing plate where the ink filament is normally placed. In particular, this can also be used to compare the deposited ink filament with the calibration filaments. In the latter case, it is less a calibration per se than a kind of interpolation method or nearest-neighbor method in which the geometry of the ink filament currently being considered is compared with the calibration filaments.

Preferably, the calibration filaments are made of a transparent material, particularly one with a refractive index comparable to the (bio) ink and/or with a filament width and/or cross-sectional area comparable to the expected filament widths or cross-sectional areas. In particular, the calibration filaments are made of one or different (types of) liquid silicone rubber. The term “comparable” here specifically means that the refractive index must lie within a range with a specified tolerance (e.g., +/−10%) around the value of the corresponding parameter of the ink. In terms of filament widths or cross-sectional areas, different calibration filaments with widths from 1 mm to 10 mm and variations in filament heights from 0.1 mm to 2 mm are preferably used.

In an optional design, the 3D printer also features a radar sensor which is designed to detect, at least locally (i.e., particularly the manner of a cross-sectional image), the width, curvature, and/or height of the deposited ink filament during the specified printing operation of the 3D printer and to transmit this information to the controller. The controller is, for example, designed to use this local information as a characteristic value when determining the throughput and/or printing speed. In particular, the data (dimensions) captured and transmitted by the radar sensor are used in this case to support or verify the dimensions captured and determined by the optical capture device. The radar sensor is embodied, for example, as a UWB radar sensor (“ultra-wide-band”). Such a sensor has a comparatively high spatial resolution as well as the ability to “see through” some structures (materials). The radar sensor can be optionally directed at the printing plate from below, just like the optical capture device, and must therefore shine through it. Alternatively, the radar sensor is more conveniently located above the printing plate in order to enable measurements to be performed directly on the deposited ink filament.

The advantage of the optical capture device (i.e., optical capture itself) is fundamentally that its field of view is normally larger than that of the radar sensor, so that a larger area can be captured and evaluated in a single “glance.” By comparison, the radar sensor can usually only capture a relatively narrow area (e.g., approximately in a linear pattern). Nevertheless, the 3D printer with the radar sensor for (at least local) detection of the width, curvature, and/or height, i.e., in particular the filament geometry, optionally also constitutes a discrete invention that is independent of the presence of the optical capture device. Expressed differently, in this case the 3D printer may feature the print head, the (optionally radar-transparent) printing plate for depositing the extruded ink filament, as well as the above-described radar sensor and the controller. In this embodiment, the imaging apparatus and the optical capture device can also be omitted. In this variant, the controller is specifically configured to deduce the volumetric throughput from the dimensions of the width, curvature, and/or height of the inkjet determined by the radar sensor.

Here and below, “characteristic” means in particular that the quantity to be determined includes quantitative information about the quantity of the respective corresponding process or material parameter (e.g., throughput or spreading behavior) so that this information can be read out unambiguously from the quantity.

However, the quantity to be determined can also be a quantity that is directly or indirectly proportional to the process or material parameter or that has a nonlinear relationship with it, for example one that is logarithmic, exponential or polynomial (i.e., quadratic, cubic, etc.).

The conjunction “and/or” is to be understood here and in the following specifically such that the features linked by this conjunction can be formed both jointly and as alternatives to one another.

Other features which are considered as characteristic for the invention are set forth in the appended claims.

Although the invention is illustrated and described herein as embodied in a 3D printer, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic side view of a 3D printer;

FIG. 2 is an illustration of an image of a part of the 3D printer captured by an optical capture device;

FIG. 3 is a schematic side view of an optical model for an evaluation of the image; and

FIG. 4 is an illustration showing an alternative exemplary embodiment of the 3D printer in a view according to FIG. 2.

### DETAILED DESCRIPTION OF THE INVENTION

Analogous parts are always provided with the same reference symbols in all figures.

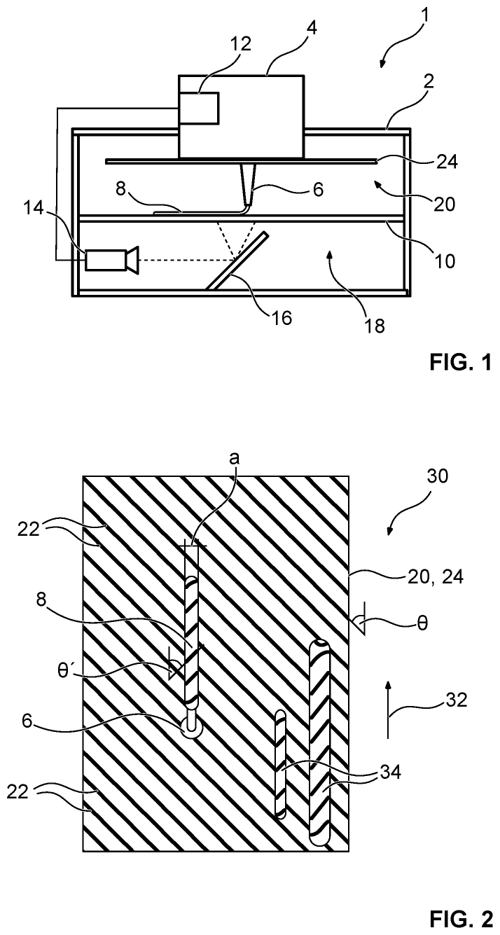

Referring now to the figures of the drawings in detail and first, particularly to FIG. 1 thereof, there is shown a 3D printer 1. It has a portal frame 2 on which a printing unit 4 is suspended. The printing unit 4 has a reservoir for the material to be printed, this being “bioink” for re-forming body tissue in the present exemplary embodiment. Furthermore, the printing unit 4 has a print head, represented here by a print nozzle 6, through which an ink filament 8 is extruded. The 3D printer 1 also has a printing plate 10 for depositing the ink filament 8. The printing plate 10 is configured to be transparent, being made, for example, of glass, or alternatively of polystyrene. The printing unit 4 also has a drive (not shown in further detail) by means of which at least the print nozzle 6 (but usually the entire printing unit 4) can be moved in a plane parallel to the printing plate 10. To control a printing operation, the 3D printer 1 has a controller 12 which, in the present exemplary embodiment, is integrated into the printing unit 4. Alternatively, the controller 12 can also be instantiated by a computer that is connected to the printing unit 4 by data transmission technology.

To monitor a printing operation, the 3D printer 1 also has an optical capture device, specifically a camera 14. This is connected to the controller 12 by data transmission technology. The camera 14 is installed in such a way that—for the purpose of saving installation space in the present exemplary embodiment—it is arranged below a plane of the printing plate 10 and its field of view is directed by means of a mirror 16 from a bottom side 18 onto-more precisely through—the printing plate 10. Furthermore, the 3D printer 1 has an imaging apparatus 20 which provides a pattern of straight—in the present embodiment also parallel—stripes 22 (see FIG. 2) which, in turn, can be viewed (i.e., captured) through the printing plate 10 by means of the camera 14. Specifically, the imaging apparatus 20 is instantiated by a plate 24 on which the stripes 22 are printed. This plate 24 is coupled to the printing unit 4. The print nozzle 6 protrudes through the plate 24. The plate 24 is therefore moved along with the print nozzle 6. In an alternative exemplary embodiment, the camera 14 can also be positioned so that it “looks” through the printing plate 10 without a mirror, meaning that it is aligned vertically with its optical axis.

The controller 12 is configured to carry out a method for operating the 3D printer 1, which will be described in greater detail below. For this purpose, the controller 12 uses the camera 14 to continuously capture images of the printing plate 10, the ink filament 8 placed thereon, and thus also of the stripes 22 during a printing operation, i.e., while the ink filament 8 is being deposited. Since the deposited ink filament 8 varies in width, exit cross section (i.e., upon emerging from the print nozzle 6), and also in its spreading behavior (i.e., how much the ink filament 8 spreads across the printing plate 10) as a function of process settings such as throughput and printing speed, the stripes are distorted differently by the respective ink filament 8. An image 30 captured by the camera 14 is shown by way of example in FIG. 2.

The method employed by the controller 12 is based on the assumption that the deposited and spread ink filament 8 behaves similarly to a cylindrical lens. This is indicated by the fact that the stripes 22 are twisted at least in a central longitudinal region of the ink filament 8. The controller 12 determines the current (and local) width a of the ink filament 8. This can be done, for example, using the optically detectable (longitudinally extending) outer edges of the ink filament 8. Furthermore, the controller 12 determines a curvature of the ink filament 8 using an optical calculation method described in more detail below as an example. Here, the controller 12 bases its calculations on the rotation of the stripes 22, which, in the present exemplary embodiment, extends at 45 degrees to a main printing direction 32 and thus also at 45 degrees to the alignment of the ink filament 8. For this purpose, the controller 12 determines an angle θ for the alignment of the stripes 22 (specifically, exactly one stripe 22) relative to the main printing direction 32 without deflection by the ink filament 8 and an angle θ′ for the alignment of a stripe 22 that was imaged through the ink filament 8 and thus deflected (i.e., distorted, in particular twisted).

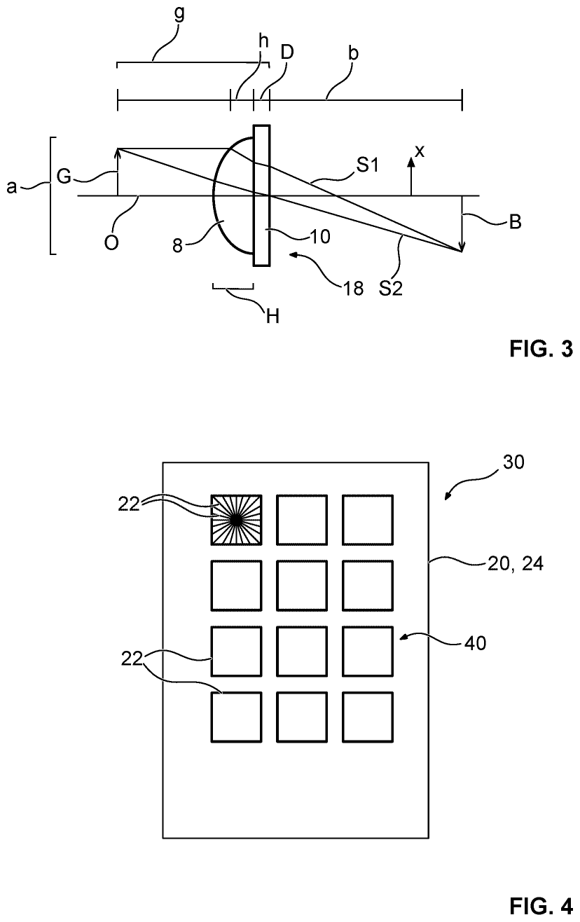

FIG. 3 now illustrates, by way of example, how the optical calculation method is carried out. Specifically, this involves a paraxial approximation using matrix optics. In FIG. 3, the ink filament 8 is shown in section and forms a cylindrical lens that rests on the printing plate 10. For the beam path originating from an object point, specifically a point that is part of a stripe 22 and is arranged at a distance G (“object size”) from the optical axis O, the following equation is obtained for its exit vector [symbol] under the assumption that the beam path (exemplified here by a first beam S1) initially runs parallel to the optical axis O up to the ink filament 8 on the bottom side 18 of the printing plate 10:

$$\vec{{h}_{out}} = {B}_{3} {T}_{3} {B}_{2} {T}_{2} {B}_{1} {T}_{1} \vec{{h}_{ι n}} \qquad ( 1 )$$

where:
[symbol] is the entry vector of the beam path for the beam S1 at the inkjet 8, whose vector components represent the distance G and the angle in radians from the optical axis O,
T₁ is the translation matrix between the object and the entry into the ink filament 8,
B₁ is the refractive matrix upon entering the ink filament 8,
T₂ is the translation matrix in the ink filament 8 to the printing plate 10,
B₂ is the refractive matrix upon passing into the printing plate 10,
T₃ is the translation matrix in the printing plate 10, and
B₃ is the refractive matrix upon exiting the printing plate 10.

Analogously to [symbol] , the components of the vector [symbol] also express the distance and the angle in radians from the optical axis of the corresponding beam at the exit point, specifically at the ‘endpoint’ of this beam used for equation (1).

This can be written out as:

$$\vec{{h}_{out}} = [ \begin{matrix}1 & 0 \\ 0 & {n}_{g}\end{matrix} ] [ \begin{matrix}1 & D \\ 0 & 1\end{matrix} ] [ \begin{matrix}1 & 0 \\ 0 & n / {n}_{g}\end{matrix} ] ( \begin{matrix}1 & h \\ 0 & 1\end{matrix} ) ( \begin{matrix}1 & 0 \\ ( 1 / n - 1 ) & 1 / n\end{matrix} ) ( \begin{matrix}1 & ( g - h - D ) \\ 0 & 1\end{matrix} ) [ \begin{matrix}G \\ 0\end{matrix} ] \qquad ( 2 )$$

where:
n_{g} is the refractive index of the printing plate 10 (assumed here to be glass),
n is the refractive index of the ink filament 8,
g is the distance from the object to the bottom side 18 of the printing plate 10 (“object distance”),
h is the local height (or thickness) of the ink filament 8 at the entry point,
D is the thickness of the printing plate 10, and
p is the curvature of the ink filament 8.

The exit vector [symbol] can also be determined analogously for the second beam S2. From this, the image distance b and the image size B can then be advantageously determined from the intersection point of the two beams S1 and S2.

The curvature ρ can be determined from the experimentally accessible relationship

$$tan ∅ / tan {∅}^{′} = G / B \qquad ( 3 )$$

between the known object size G and known object distance g and the calculable image size B. The maximum height H, in turn, can be determined on the basis of this and the optically detectable width a of the ink filament 8:

$$h ( x ) = H ( 1 - {( 2 x / a )}^{2} ) . \qquad ( 4 )$$

The curvature ρ is obtained through twofold differentiation of equation (4) and taking the absolute value as

$$p = 8 H / {a}^{2} \qquad ( 5 )$$

it being possible, in turn, to determine the maximum height H through rearrangement, since the curvature ρ can be determined from equation (3).

Based on the height H and the curvature ρ, it is now also possible to determine the cross-sectional area A of the ink filament 8 (and thus, if the printing speed is known, the throughput).

Furthermore, the cross-sectional area A can also be determined from equation (4) if the height H and width a are known:

$$A = {\int }_{- \frac{a}{2}}^{+ \frac{a}{2}} h ( x ) \cdot dx . \qquad ( 6 )$$

This, in turn, yields:

$$A = \frac{2}{3} \cdot a \cdot H . \qquad ( 7 )$$

The product of the cross-sectional area A and the printing speed yields the (volume) throughput of printing ink (this being an alginate-based bioink in the present exemplary embodiment). The throughput is a quantity that is difficult to determine from other process data, particularly control variables such as pressure acting on the ink.

As a matter of principle, the two beams S1 and S2 (or any other beams passing through the ink filament 8) provide their intersection point “B”, i.e., the image size B. In order to solve equation (2), however, it is also necessary to specify, or more precisely know, the respective (local) filament height h. Since the x-coordinate is uniquely determined (calculable) from the geometry and choice of the starting angle of the respective beam S1 or S2 relative to the optical axis, the corresponding local height h can be determined using a value for the maximum height H and the width a. Likewise, the curvature p contained in equation (2) is given by equation (5). Therefore, the maximum height H is the only free parameter of equation (2). The height H is now expediently varied (iterated) until the calculated ratio of object size G and image size B corresponds to the experimentally accessible tan θ/tan θ′, i.e., until equation (3) is satisfied.

The choice of a value for the object size G in equation (2) is arbitrary in principle, as long as the value lies in the interval 0<G<a/2, preferably in the interval a/10<G<a/4. The first beam S1 is preferably chosen with the starting angle 0 relative to the optical axis (parallel to the optical axis) (see FIG. 3). An expedient starting angle for the second beam S2 relative to the optical axis is determined by the ratio of the chosen object size G to the object distance g. The following orders of magnitude can typically be assumed: the object distance g is typically 25 mm (particularly +/−5 mm), the width a of the ink filament 8 is in the range of 0.1 to 1 mm, and the maximum height H is less than the width a. Based on these orders of magnitude, it is clear that the use of the paraxial approximation described above is justified.

Optionally, the controller 12 also determines a development of the width of the ink filament 8 over time based on multiple successive images 30, and optionally also the curvature and/or height thereof. From this, it can be deduced how strongly and for how long the ink tends to spread, or how strongly the ink filament 8 spreads under given process parameters. This information is important in order to better assess and/or control the possibilities for constructing three-dimensional structures.

In order to train and/or check the optical capture of the dimensions and the calculation of the curvature, etc., of the ink filament 8, multiple—specifically two—calibration filaments 34 are arranged on the printing plate 10. These are made of a material with a known optical refractive index (specifically, a refractive index approximating that of the ink), this being a liquid silicone rubber in the present exemplary embodiment. In the present exemplary embodiment, one of the two calibration filaments 34 is deposited with a liquid silicone rubber with low spreading and thus small width, and the other with higher throughput but also with a liquid silicone rubber with greater spreading and thus larger width. The width, curvature, and height of the calibration filaments 34 are known. This makes it possible to verify whether the calculation of the controller 12 is correct. Alternatively, the controller can also approximate the dimensions of the ink filament 8 by comparing and interpolating between the known calibration filaments 34. The calibration filaments 34 are crosslinked (“cured”) and can therefore be reused together with the printing plate 10.

FIG. 4 shows an image of an alternative imaging apparatus 20. The pattern formed by the stripes 22 is different here. The stripes 22 form a plurality of squares 40 with an edge length of 3 cm. As another exemplary embodiment, a plurality of stripes 22 are arranged in a star-shaped or radial manner toward each other—shown here in one of the squares 40. In the present exemplary embodiment, the beams 22 are arranged so as to be rotated by 15° relative to one another. Such patterns also enable any printing direction to be set for the ink filament 8 and still be assessed with comparatively high reliability according to the scheme described above.

The subject matter of the invention is not limited to the exemplary embodiment described above. Rather, other embodiments of the invention may be derived from the description above by a person skilled in the art.

The following is a summary list of reference numerals and the corresponding structure used in the above description of the invention:
1 3D printer
2 portal frame
4 printing unit
6 print nozzle
8 ink filament
10 printing plate
12 controller
14 camera
16 mirror
18 bottom side
20 imaging apparatus
22 stripe(s)
24 plate
30 image
32 main printing direction
34 calibration filament
40 square
a width
θ, θ′ angle
G distance
O printing plate
g distance
h height
H maximum height
D thickness
B distance
S1 beam
S2 beam

1. A 3D printer, comprising:
a print head for extruding a transparent ink filament;
a transparent printing plate for depositing extruded ink filament;
an imaging apparatus providing a pattern composed at least of straight stripes;
an optical capture device configured to capture an image of the pattern and of deposited ink filament from a bottom side of said transparent printing plate during a specified printing operation of the 3D printer; and
a controller configured to derive at least one characteristic value for the specified printing operation from the image captured by means of said capture device.

2. The 3D printer according to claim 1, wherein said imaging apparatus has a plate on which the pattern has been printed.

3. The 3D printer according to claim 1, wherein said imaging apparatus has a screen on which the pattern is displayed.

4. The 3D printer according to claim 1, wherein said controller is configured to infer a width, a curvature, and/or a height of the deposited ink filament based on an optical distortion of the pattern in the image.

5. The 3D printer according to claim 1, wherein the stripes of the pattern are positioned at an angle of at least approximately 45° to a main printing direction.

6. The 3D printer according to claim 4, wherein said controller is configured to infer a throughput and/or printing speed as the at least one characteristic value from the width as well as the curvature and/or the height of the deposited ink filament.

7. The 3D printer according to claim 5, wherein said controller is configured to infer a spreading behavior of an ink used for the ink filament based on a progression of the width, the curvature, and/or the height of the deposited ink filament over time.

8. The 3D printer according to claim 1, wherein said controller is configured to detect, in a calibration mode, a plurality of calibration filaments which are disposed on said transparent printing plate or on a support to be placed thereon and which have a known cross-sectional geometry and to use them to compensate for measurement deviations.

9. The 3D printer according to claim 8, wherein the calibration filaments are made of a material with a refractive index and/or viscosity comparable to ink.

10. The 3D printer according to claim 1, further comprising a radar sensor configured to detect, at least locally, information on the width, the curvature, and/or the height of the deposited ink filament during the specified printing operation of the 3D printer and to supply the information to said controller as the at least one characteristic value for determining a throughput and/or printing speed.

11. A method for operating a 3D printer, which comprises the steps of:
extruding a transparent ink filament by means of a print head of the 3D printer and deposited on a transparent printing plate;
using an imaging apparatus to provide a pattern composed at least of straight stripes;
capturing an image of the pattern and of deposited ink filament from a bottom side of the transparent printing plate; and
deriving at least one characteristic value for a printing operation from a captured image.
